(19) United States
(12) Patent Application Publication
(10) Pub. No.: US 2011/0055079 A1
(43) Pub. Date: Mar. 3, 2011

(54) REAL TIME ACCOUNTS PAYABLE WEB SERVICE

(76) Inventors: David Meaney, San Francisco, CA (US); Richard Mitchell Eastley, Woodside, CA (US)

(21) Appl. No.: 12/868,436

(22) Filed: Aug. 25, 2010

Related U.S. Application Data
(60) Provisional application No. 61/238,648, filed on Aug. 31, 2009.

(51) Int. Cl. G06Q 40/00

(52) U.S. Cl. 705/40

(57) ABSTRACT

A web service facilitates real time payment of suppliers' invoices with accounts issued by issuers to account holders. A payment request received by the web service from a client, identifying a credit limit for one commercial account in a pool thereof, is sent from the web service to the issuer to determine availability of the account and the credit limit for an account holder. If the issuer's response to the request confirms availability, payment instructions to the issuer are sent from the web service to pay the supplier's invoice. Alternatively, the request can be to determine availability of a single-use-account (SUA) and an adjustment to the account holder's credit limit from the issuer in order to make a future single payment on the SUA to the supplier for a purchase corresponding to a future invoice from the supplier who has not yet provided goods and/or services pertaining to the invoice.

### CROSS-REFERENCE TO RELATED APPLICATIONS

This application claims priority to, and the benefit of, U.S. Provisional Application Ser. No. 61/238,648, filed on Aug. 31, 2009, titled “Real Time Accounts Payable Web Services,” which is incorporated herein by reference.

### FIELD

The present invention is related to accounts payable of a business to its past or future suppliers, and is more particularly related to accounts payable web services.

### BACKGROUND

To run a business, raw materials, finished goods, and supplies are needed by the business. Additionally, the business needs various service providers. Whether goods or services are provided to the business, each such supplier must be paid for those goods and services provided to the business. Each supplier sends an invoice to the business in order to be paid for the goods and service that it delivers to the business. The invoice is the means by which the supplier is compensated by the business for the goods and services that the business has received or will receive. After receipt of an invoice by the business, a supplier who sent the invoice will typically wait a number of days before being paid by the business to which goods and/or services were provided. The business typically pays its supplier through an accounts payable system. The payment of the supplier by the business can be by cash, check, or via a payment on an account that was issued to the business by a issuer such as the business's bank. It may be particularly advantageous to pay each supplier on an account. These advantages include incentives and rebates from the issuer who finances the business's payments to its suppliers, the lower cost to the business of electronic payment processing as opposed to processing payments by check, the ‘float’ advantage to the business of stalling the actual out flow of cash by use of credit so in paying its suppliers so as to maximize working capital, etc.

A business will typically receive numerous invoices from its suppliers for goods and services that have already been provided to the business by its respective suppliers. Periodically, the business will identify those invoices it wishes to pay from among those invoices it has received. To pay each invoice, a collaborative work flow may be required throughout the business's organizations (e.g.; treasury, finance, accounts payable, audit and compliance, information technology, procurement, etc.) to secure and control approval for payment.

Once a set of invoices to be paid has been identified, a method of payment for each invoice is further determined. In the case of those invoices that are to be paid upon an account issued to the business by an issuer, a batch process is typically used. The account upon which the business pays its account payable is often referred to a commercial account, or alternatively an account corresponding to a ‘commercial card’. The commercial account can have funds on deposit, or it can be a revolving credit account, or a one-time-only use credit account (e.g.; spot credit).

In the accounts payable batch process, a group of invoices (e.g., a batch of invoices) is identified by the business for payment by way of processing through the business's accounts payment system. An issuer of the business's commercial account will receive the batch of invoices. Daily, the business may send one (1) batch of invoices to its commercial account issuer. The issuer will then transfer funds to each supplier for its corresponding invoice in the batch. In the case where the issuer is financing the accounts payable, the business will be financially responsible for depositing funds with the issuer sufficient to pay the issuer for payments made on the account to the business's suppliers that correspond to the batch of invoices, plus services charges, interest, and penalties. The issuer may provide rewards, incentives, and rebates to the business for its loyalty to the issuer in agreeing to allow the issuer to finance the business's accounts payables.

In the case where a supplier offers an incentive to a business to make an immediate payment for an invoice, prior art batch processing of accounts payable for payment on a commercial account is inadequate due to latency. Accordingly, it would be an advantage to provide a business with a real time payment accounts payable function by which the business can make a real time payment electronic payment on the business's commercial account.

### SUMMARY

In one implementation, a request is received from a client, at a web service, to identify one commercial account in a pool of commercial accounts. The request includes a credit limit for the requested unused one commercial account. The web service sends to the request to an issuer of the requested unused one commercial account along with instructions that the issuer determine the availability of the requested unused one commercial account in the pool of commercial accounts, as well as the availability of the credit limit from available credit offered by the issuer to an account holder to whom the issuer issued each commercial account in the pool of commercial accounts. The web service will be receiving, from the issuer, a response to the request. When the response includes a confirmation as to the availability of both the requested unused one commercial account and the requested credit limit for the requested unused one commercial account, the web service sends payment instructions to the issuer to make an electronic payment of the invoice to the supplier by use of the available credit limit of the requested unused one commercial account in amount. The f the request and is response occur in real time. In an alternative implementation, the request and its response, as well as the payment instructions, are contained in one or more transmissions having data in a format of a markup language.

In another implementation, a requested is received by a web service from a client. The request includes instructions to determine whether an adjustment is available for a credit limit by a currency amount for single use of a commercial account that is a Single-Use-Account (SUA). The SUA is to be used to make a future single payment thereon to a supplier of an account holder to whom an issuer issued the SUA. The single payment is for an invoice from the supplier who has not yet provided goods and/or services pertaining to the invoice. The web service sends the request to an issuer of the SUA along with an identifier for the SUA and the currency amount. The request includes instructions that the issuer make a determination as to the availability of the requested adjustment to the credit limit of the SUA by the currency amount from available credit offered by the issuer of the SUA who issued the SUA to the account holder. The web service receives, in response to the request, a response to the request. When the response includes information verifying that both the SUA and the requested credit limit adjustment for the SUA have been determined by the issuer to be available, the web service sends payment instructions to the issuer to make a single payment pertaining to the supplier's invoice by use of the adjusted credit limit of the SUA. The request and its response occur in real time. In an alternative to the foregoing implementation, electronic communications pertaining to each of the received request and the received response to the request, and the payment instructions sent to the issuer, are one or more transmissions containing data in a format of a markup language.

In yet another implementation, an ‘Update Payment Instructions/Requisition Request Web Service’ is provided to update existing payment instructions or requests, as described above, as are in a pending state.

In a still further implementation, a ‘Resend Notifications Request Web Service’ is provided to request a resending of the payment instructions or requests, as described above, as are in a pending state.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary method for a Payment Instructions Web Service;

FIG. 2 illustrates an exemplary method for a Requisition Request Web Service;

FIG. 3 illustrates an exemplary method for an Update Payment Instructions/Requisition Request Web Service;

FIGS. 4 and 5 show respective exemplary backend processing flows, where FIG. 4 shows a process for payment instruction and requisition requests, and where FIG. 5 shows a process for periodic batch matching and expiration processing;

FIG. 6 depicts a flow chart of an exemplary method for processing of a request from a client for the Payment Instructions Web Service of FIG. 1, the Requisition Request Web Service of FIG. 2, or the Update Payment Instructions/Requisition Request Web Service for FIG. 3;

FIG. 7 depicts an automated web service environment to illustrate, using a flow diagram, an accounts payable automation web service in which various network devices are in communication; and

FIG. 8 illustrates an exemplary payment processing network to depict the general environment in which a transaction on a commercial account can be processed for payment, where a business is the holder of the commercial account issued to the business by an issuer, and the transaction on the commercial account is conducted by the business with a merchant (e.g.; a supplier to the business) in exchange for the merchant's supply of goods and/or services to the business.

### DETAILED DESCRIPTION

A ‘Payment Instructions Web Service’ is provided on the World Wide Web. The Payment Instructions Web Service allows a business to make a real time, electronic payment (e-payment) to its supplier for goods and/services already received and./or provided by the supplier to the business. The real time e-payment is made on a commercial account that was issued to the business by an issuer. The business's request to make the real time, electronic payment is referred to herein as ‘payment instructions’. Accordingly, when a supplier offers an incentive to the business to make an immediate payment for its invoice, the real time e-payment on the business's commercial account via the Payment Instructions Web Service will allow the business to collect the incentive that would otherwise have been lost by prior art batch processing of accounts payable. Moreover, the business will enjoy the convenience of Web-based e-payment to maximize its working capital while automating the payment instructions aspect of its account payables processes.

In use, the Payment Instructions Web Service enables the creating of payment instructions to direct a supplier to use the business's commercial account to pay for purchases that have already been made and invoiced to the business (e.g.; the buyer company). The Payment Instructions Web Service can be used to process an “Adhoc” payment instruction in an Accounts Payable Automation application. The Payment Instructions Web Service will capture a single payment instruction for one call to the Payment Instructions Web Service. The payment instruction will be processed based on the data received. At the conclusion of processing, a response will be provided for the completion status for the payment instruction.

In one implementation, the Payment Instructions Web Service will receive from a client a request to identify one commercial account in a pool of commercial accounts. The one commercial account will be unused and other commercial accounts in the pool have been used or are already in use. The requested one unused commercial account is to be used to make one payment thereon to a supplier of an account holder of the requested unused one commercial account. The one payment is for an invoice from the supplier. The request received by the Payment Instructions Web Service will include a credit limit for the requested unused one commercial account. The Payment Instructions Web Service sends to the request an issuer of the requested unused one commercial account along with instructions that the issuer determine the availability of the requested unused one commercial account in the pool of commercial accounts, as well as the availability of the credit limit from available credit offered by the issuer to an account holder to whom the issuer issued each commercial account in the pool of commercial accounts.

The Payment Instructions Web Service receives, from the issuer, a response to the request. When the response includes a confirmation as to the availability of both the requested unused one commercial account and the requested credit limit for the requested unused one commercial account, the Payment Instructions Web Service sends payment instructions to the issuer to make an electronic payment of the invoice to the supplier by use of the available credit limit of the requested unused one commercial account in amount. Preferably both the receiving of the request and the response that is received to the request will all occur in real time. It is also preferable that each of the received request and the received response to the request all be one or more transmissions containing data in a format of a markup language, and that the payment instructions sent to the issuer be one or more transmissions containing data in a format of a markup language.

A ‘Requisition Request Web Service’ is also provided. In the Requisition Request Web Service, a business can designate a commercial account upon which a future payment can be made for goods and/or services not yet received by the business from a supplier to whom the future payment is to be made. In this case, the commercial account will be a Single Use Account (SUA), in that the account will only be used by the business to make one payment to one supplier. Alternatively, the business can ask for an adjustment to a credit line of one of the business's existing commercial accounts. The requested adjustment to the commercial account's credit limit is made so that the business can make one or more future payments for goods and/or services that have not yet received by the business from a supplier to whom the future payment(s) is/are to be made. The Requisition Request Web Service is referred to herein as having a ‘requisition’ function, in that the business requisitions a SUA for a single use to pay a supplier, or in that the business requisitions an adjustment of an existing commercial account's credit limit in order to make one or more payments to the business's supplier.

In use, the Requisition Request Web Service enables the creating of requisitions to provide an ‘open to buy’ credit limit to a business of a ‘buyer company’. The buyer company will use information about the requisitioned commercial account provided by the Requisition Request Web Service in order to initiate future purchases from future suppliers. The Requisition Request Web Service can provide this information in conjunction with the issuance of a Single-Use-Account (SUA) that is a commercial account, or in conjunction with an adjustment to the credit limit on an existing commercial card. The Requisition Request Web Service, in sum, is for creating a new requisition and issuing a Single-Use-Account, or for updating a credit limit for an existing commercial account that is related to the requisition.

In one implementation, a requested is received by the Requisition Request Web Service a client. The request is to adjust a credit limit by a currency amount for a single use of an SUA. The SUA is to be used to make a single payment thereon to a supplier of an account holder to whom an issuer issued the SUA, and the payment is for an invoice from the supplier. The Requisition Request Web Service sends the request to an issuer of the SUA along with an identifier for the SUA and the currency amount. The request includes instructions that the issuer make a determination as to the availability of the requested adjustment to the credit limit for the SUA by the currency amount from available credit offered by the issuer of the SUA who issued the SUA to the account holder. The Requisition Request Web Service receives, in response to the request, a response to the request. When the response includes information verifying that both the SUA and the requested credit limit adjustment for the SUA are determined to be available, the Requisition Request Web Service sends payment instructions to the issuer to make a single payment of the invoice to the supplier by use of the adjusted credit limit of the SUA account. Preferably, the request and its response all occur in real time. It is also preferable that electronic communications pertaining to each of the received request and the received response to the request are as one or more transmissions containing data in a format of a markup language, and that the payment instructions sent to the issuer be one or more transmissions containing data in a format of a markup language.

An ‘Update Payment Instructions/Requisition Request Web Service’ is also provided. The Update Payment Instructions/Requisition Request Web Service is for updating existing Payment Instructions or Requisition Requests, as described above, that are in pending state (not yet matched or expired) within an accounts payment automation platform. Supported changes include adjusting an expiration date for use of a commercial account, replacing contact information (e.g.; email addresses and email notes), include updating the payment amount or reviving an expired payment instruction.

A ‘Resend Notifications Request Web Service’ is also provided. The Resend Notifications Request Web Service is to request a resending of the payment instruction(s) and/or requisition request notification/remittance e-mail(s). The notification/remittance can be sent to a recipient list that is currently persisted as part of the payment instruction/requisition request being referenced.

A ‘Get Single-Use-Account Inventory Request Web Service’ is also provided. The Get Single-Use-Account Inventory Request Web Service is to request a report of the total number of single use commercial accounts (SUAs) that have been issued by an issuer to a business (e.g., to a bank's business customer) that are in a pool of commercial accounts that have been set aside for the business's use. The report will also include the number of such commercial accounts that are currently available to be used by the business for new requests. Such pools of commercial account can be defined, for example, by the business (e.g.; buyer IDentification (ID)) and a distinct proxy account number for the commercial account.

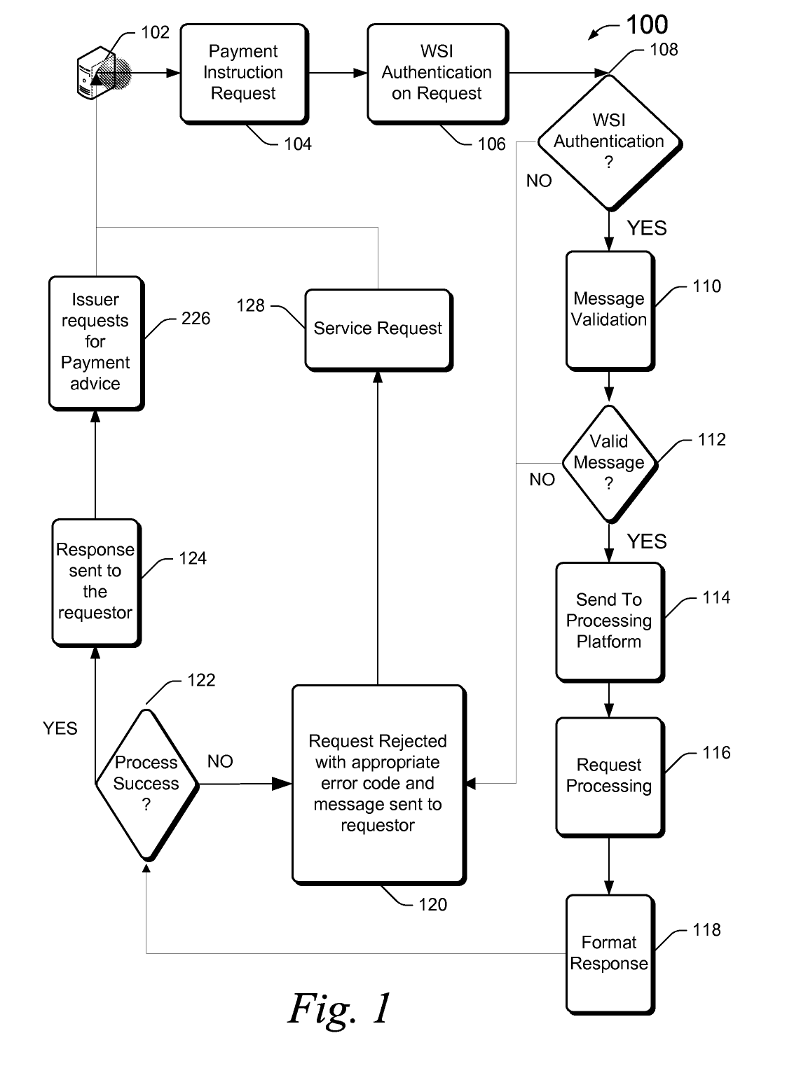

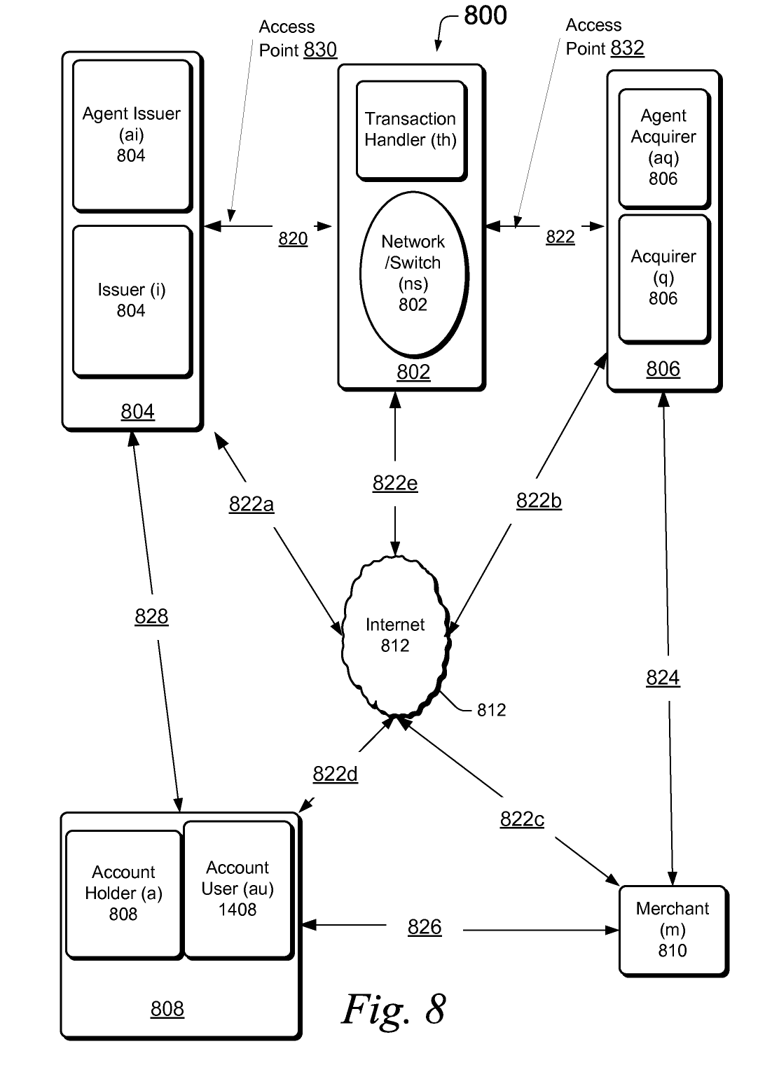

In each of FIGS. 1-3, a requestor-client is seen at blocks 102, 202, 302, respectively. The requestor-client is an entity pursuing a payment of its accounts payable by working with an issuer such as is found and will be discussed further in FIG. 8, at reference 804 (i). By way of example, FIG. 8 shows an account holder (a) 808 that is responsible for paying a merchant (m) 810 in a transaction payment network 800. The account holder (a) 808 works with issuer (i) 804 to provide either a Single-Use-Account (SAU) that will be held by the account holder (a) 808, or an expansion of credit on an existing commercial account, so that the merchant (m) 810 can be paid in a transaction on the commercial account. In each case, the commercial account is issued to the account holder (a) 808 by issuer (i) 804.

FIG. 1 depicts a process 100 in which payment instructions are requested through a Payment Instructions Web Service provided on the World Wide Web. The Payment Instructions Web Service allows a business to make a real time, electronic payment (e-payment) to its supplier for goods and/services already received and./or provided by the supplier to the business. The real time e-payment is made on a commercial account that was issued to the business by an issuer. The business's request to make the real time, electronic payment is referred to herein as ‘payment instructions’, for instance, as seen in FIG. 1 as a payment instruction request 104. In FIG. 1, a requestor-client 102 executes a web browser, or other world wide web access application, to transmit a payment instruction request 104 to a Web Services Interface (WSI) authentication. The WSI authentication at block 106 attempts to authenticate the request for payment instructions. After the payment instructions request is subjected to a web services interface authentication at block 106, if the payment instructions request is not authenticated, then method 100 moves to block 120. At block 120, the payment instructions request is rejected with an appropriate error code and a diagnostic message is sent to the requestor-client at block 120, and process 100 moves to block 128 in which there is a service request which is further returned to the requestor-client 102. If, however, the payment instructions request is deemed to be authenticated by the query at block 108, then process 100 moves to block 110. At block 110, a message of the payment instructions request is validated in a validation process. This validation process is queried at block 112. If the validation of the message for the payment instructions request fails, then process 100 moves to block 120 where, again, the payment instructions request is rejected with an appropriate error code and a diagnostic message is sent to the requestor-client 102, and where the services requested at block 128 are for the purpose of returning the message to the requestor-client 102.

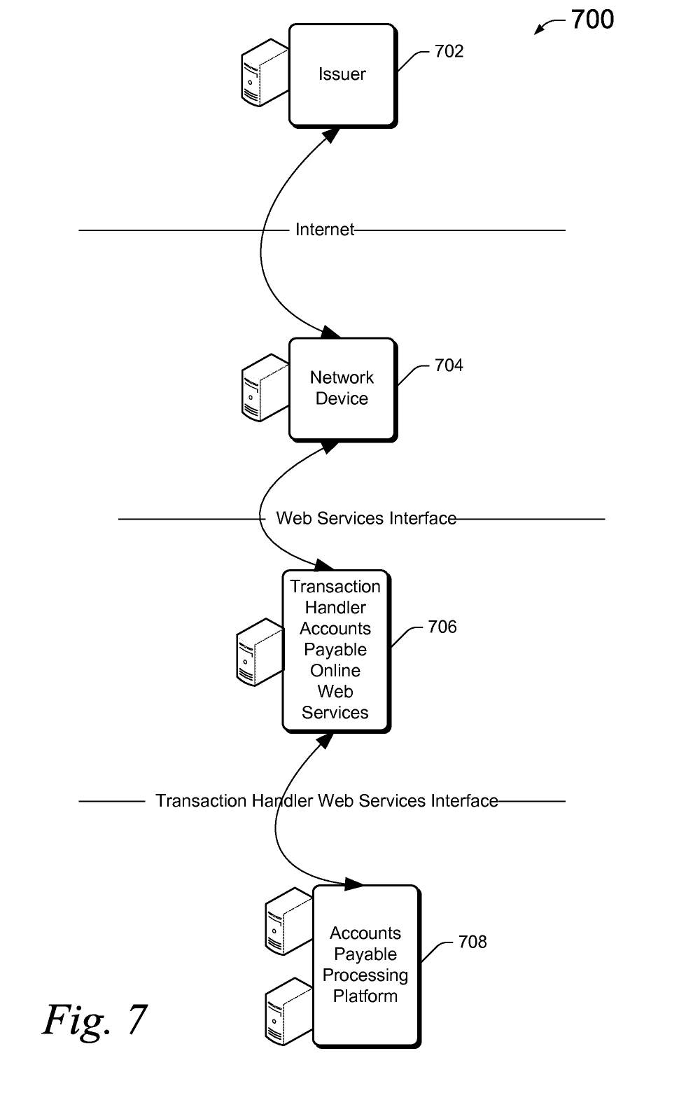

If, however, the message for the payment instructions request is deemed to be validated by the query at box 112, then process 100 moves to block 114, and the payment instructions request is sent to a processing platform. By way of example, a processing platform is seen at block 708 in FIG. 7 as an accounts payable processing platform. Process 100 moves from block 114 to block 116 where the payment instructions request is processed. At box 118, the formatting of a response to the payment instructions request is made. By way of example, the formatting is done in a mark-up language, such as eXtensible Markup Language (XML) or variation thereof, so that protocol for internet and web services can be observed and can be in compliance therewith. Process 100 moves from block 118 to block 122 where a query is made. The query at block 122 is whether the progress of the processing of the payment instructions request has been successful. If the payment instructions request for payment processing is not successful, then process 100 moves from block 122 to block 120 where the payment instructions request is rejected with an appropriate error code and a diagnostic message is sent to the requestor-client at block 102 through a service request at block 128.

If, however, the process of the processing of the payment instructions request is successful as determined by the query at block 122, then a response is sent at block 124 to the requestor-client 102, and the issuer of the commercial account makes a request for a payment advice at box 126. Thereafter, process 100 returns to the requestor-client 102 for the completion of the next real time accounts payable request for payment instructions.

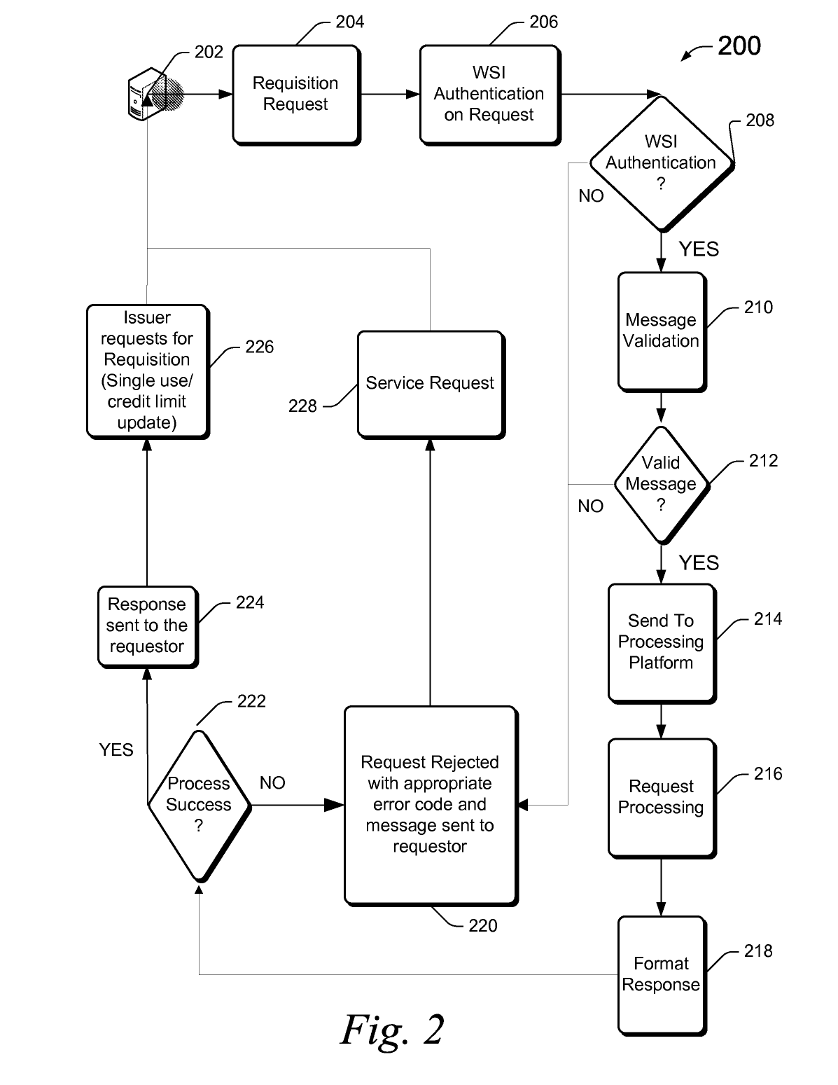

FIG. 2 shows a process 200 in which a requisition request is processed through a Requisition Request Web Service through which a business can designate a commercial account upon which a future payment can be made for goods and/or services not yet received by the business from a supplier to whom the future payment is to be made. The commercial account is a Single Use Account (SUA) for making only one payment to one supplier. Adjustments can be made to the business's credit line so that the business can make one or more future payments for goods and/or services that have not yet received by the business from the supplier to whom the future payment(s) is/are to be made.

A requestor-client 202 executes a web browser, or other world wide web access application, to transmit a requisition request 204 to a Web Services Interface (WSI) authentication at block 206. The requisition request 204 is a request for the business to requisition a SUA for a single use to pay a supplier. Alternatively, the business can requisition an adjustment to a credit limit the business's existing commercial account so that the business can make one or more payments to the business's supplier. The WSI authentication at block 206 attempts to authenticate the requisition request.

After the requisition request is subjected to a web services interface authentication at block 206, if the requisition request is not authenticated as determined by the query at block 208, then method 200 moves to block 220. At block 220, the requisition request is rejected with an appropriate error code and a diagnostic message is sent to the requestor-client 202 at block 220, and process 200 moves to block 228 at which there is a service request which is further returned to the requestor-client 202. If, however, the requisition request is deemed to be authenticated by the query at block 208, then process 200 moves to block 210. At block 210, a message of the requisition request is validated in a validation process. If the validation of the message of the requisition request fails, then process 200 moves to block 220 where, again, the requisition request is rejected with an appropriate error code and a diagnostic message is sent to the requestor-client 202, and where the services requested at block 228 are for the purpose of returning the message to the requestor-client 202.

If, however, the message of the requisition request is deemed to be validated by the query at box 212, then process 200 moves to block 214, and the requisition request is sent to a processing platform. By way of example, a processing platform is seen at block 708 in FIG. 7 as an accounts payable processing platform. Process 200 moves from block 214 to block 216 where the requisition request for payment is processed. At box 218, the formatting of a response to the requisition request is made. By way of example, the formatting is done in a mark-up language such as XML so that protocol for internet and web services can be observed and can be in compliance therewith. Process 200 moves from block 218 to block 222 where a query is made. The query at block 222 is whether the progress of the processing of the requisition request has been successful. If the requisition request is not successful, then process 200 moves from block 222 to block 220 where the requisition request is rejected with an appropriate error code and a diagnostic message is sent to the requestor-client at block 202 through a service request at block 228.

If, however, the processing of the requisition request is successful, as determined by the query at block 222, then a response is sent at block 224 to the requestor-client 202, and an issuer can act on the requisition request. The action by the issuer can be for the issuance of a Single-Use-Account (SUA) that can be used to make a future payment to a supplier. After block 226, process 200 returns to the requestor-client 202 for the completion of the next real time accounts payable requisition request.

The action by the issuer can also be to make an adjustment to the credit limit on an existing commercial account so that the commercial account will have a sufficient credit limit to make a future payment to a supplier. The credit limit for a commercial account can be adjusted up or down, either of which may affect the total credit limit that a business has with its issuer. An adjustment to increase the credit limit of an existing commercial account may reduce the amount of credit available for use by a business from an issuer, whereas an adjustment downwards may make more credit available for use to the business from the issuer for commercial accounts issued by the issuer to the business.

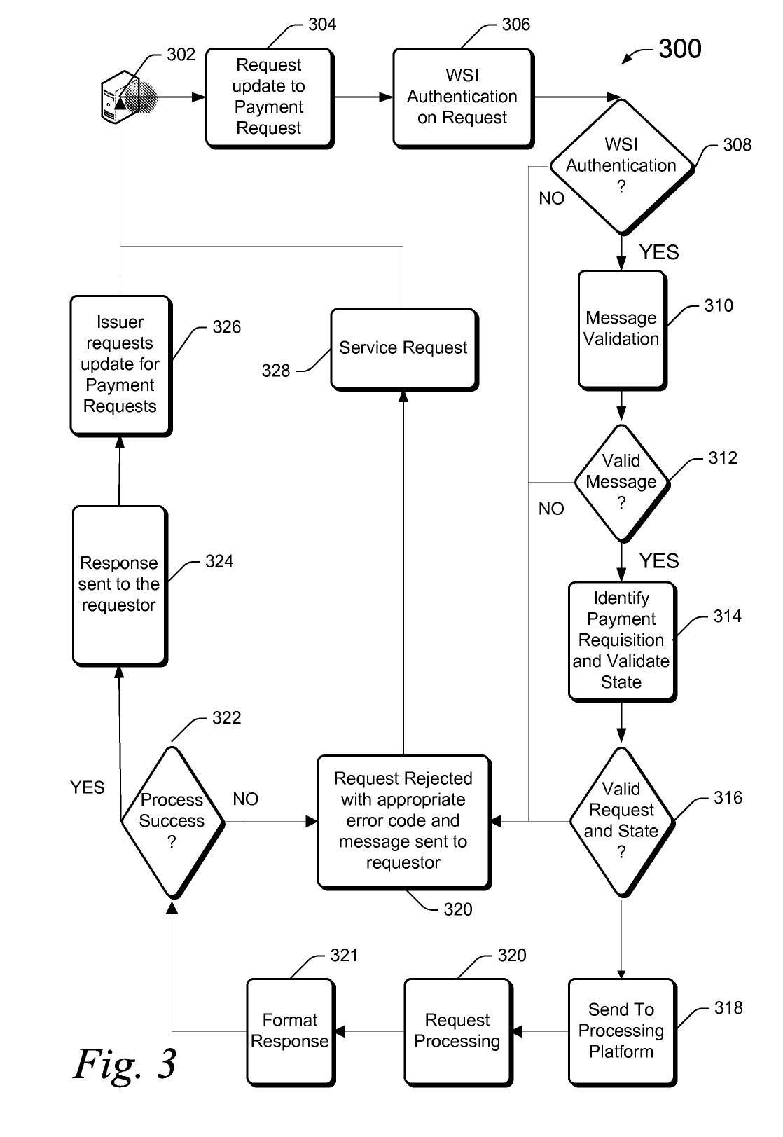

FIG. 3 shows a process 300 in which a request to update either payment instructions request or a requisition request is processed through a Update Payment Instructions/Requisition Request Web Service. This web service, which updates existing Payment Instructions Requests or Requisition Requests, pertains to those that requests that are in pending state (not yet matched or expired) within an accounts payment automation platform. Supported changes include adjusting an expiration date for use of a commercial account, replacing contact information (e.g.; email addresses and email notes), include updating the payment amount or reviving an expired payment instruction. A requestor-client 302 executes a web browser, or other world wide web access application, to transmit the update request 304 to a Web Services Interface (WSI) authentication. The WSI authentication at block 306 attempts to authenticate the update request. After the update request is subjected to a web services interface authentication at block 306, if the update request is not authenticated as determined by the query at block 308, then method 300 moves to block 320. At block 320, the update request is rejected with an appropriate error code and a diagnostic message is sent to the requestor-client 302 at block 320, and process 300 moves to block 328 at which there is a service request which is further returned to the requestor-client 302. If, however, the update request is deemed to be authenticated by the query at block 308, then process 300 moves to block 310. At block 310, a message of the update request is validated in a validation process. If the validation of the message of the update request fails, then process 300 moves to block 320 where, again, the update request is rejected with an appropriate error code and a diagnostic message is sent to the requestor-client 302, and where the services requested at block 328 are for the purpose of returning the message to the requestor-client 302.

If, however, the message of the update request is deemed to be validated by the query at box 312, process 300 moves to block 314. At block 314, an identification is made of the payment instructions or the requisition request that is to be updated. Thereafter, an attempt is made to validate the request. If the validation is not successful, as determined by the query at block 316, then process 300 moves to block 320 where the update request is rejected with an appropriate error code and a diagnostic message is sent to the requestor-client at block 302 through a service request at block 328. If the query at block 316 deems that the validation is successful, the process 300 moves to block 316 where the update request is sent to a processing platform. By way of example, a processing platform is seen at block 708 in FIG. 7 as an accounts payable processing platform. Process 300 moves from block 316 to block 318 where the update request for payment is processed. At box 321, the formatting of a response to the update request is made. By way of example, the formatting is done in a mark-up language such as XML so that protocol for internet and web services can be observed and can be in compliance therewith. Process 300 moves from block 321 to block 322 where a query is made. The query at block 322 is whether the progress of the processing of the update request has been successful. If the update request is not successful, then process 300 moves from block 322 to block 320 where the update request is rejected with an appropriate error code and a diagnostic message is sent to the requestor-client at block 302 through a service request at block 328. If, however, the processing of the update request is successful, as determined by the query at block 322, then a response is sent at block 324 to the requestor-client 302, and an issuer can act on the update request.

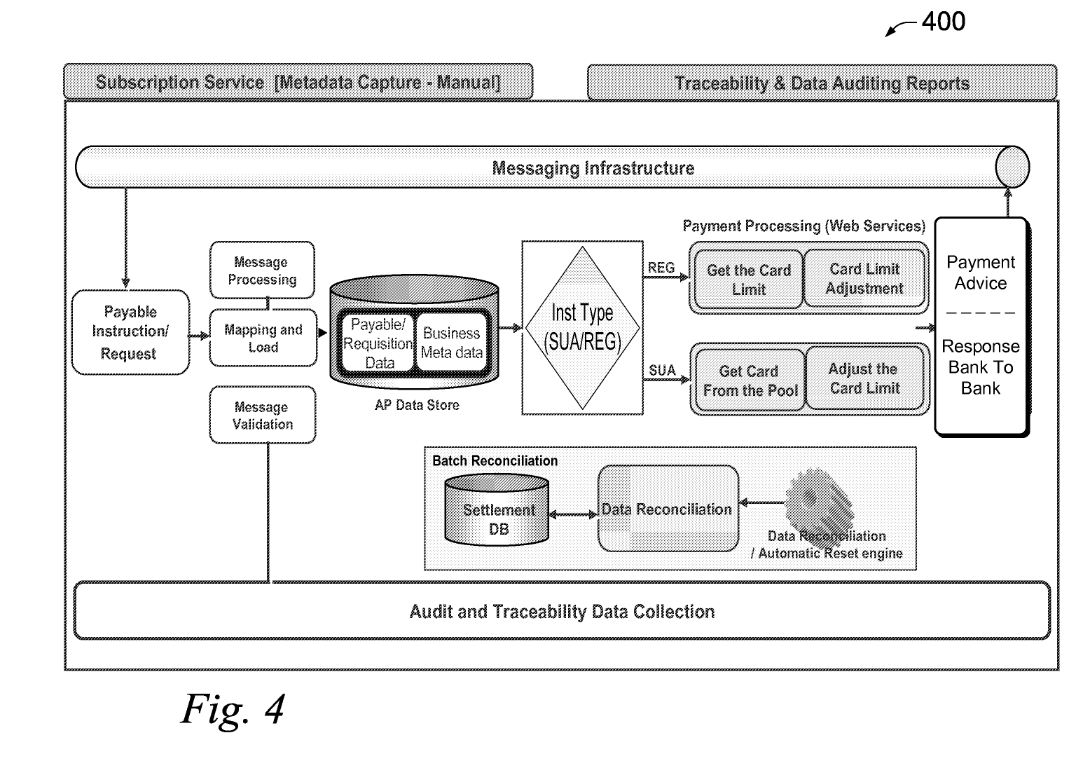

FIG. 4 shows an Environment 400 in which processes 100-300 of FIGS. 1-3, respectively, can be practiced. The Environment 400 shows a beginning box labeled “payment instructions/request”. This box shows that a real-time automatic payment instructions request or requisition request can be made to pay a merchant/supplier on a commercial account account, or a request can be made to expand the credit available on an existing commercial account so that the supplier can be paid by a holder of the commercial account. Upon such a request, mapping and loading processes feed the request to an accounts payable database store. As seen in FIG. 4, the accounts payable database store includes both payment instructions request and/requisition requests data as well as business meta data. Using these data from the accounts payable database store, a query is made as to whether the particular instructions request is for a single use commercial account (labeled ‘SUA’ in FIG. 4) that will be used for the purpose of paying a supplier only once, or whether the instructions type (labeled ‘REG’ in FIG. 4) is for an expansion of a credit line on a regular, already issued commercial account so that a supplier can be paid out of available credit for that account by the commercial account holder by way of a payment advice. Depending on the type of instruction SUA or REG, the next process is seen in FIG. 4 according to the correspondingly denoted arrows.

For the arrow labeled “REG” seen in FIG. 4, the next process will be, for the use of the existing commercial account, a retrieval of the existing card limit or the account limit to which there will be a corresponding adjustment to the credit limit of that commercial account so that a supplier can be paid by the account holder from the credit that is available for that commercial account. For the arrow labeled “SUA” seen in FIG. 4, a commercial account is retrieved from a pool of such commercial accounts that have already been issued by an issuer to the account holder. Then, there is an initial adjustment made to the credit limit to the SUA such that a supplier can be paid by the account holder by way of a payment advice.

Whether the process that has been taken is that represented by the REG arrow or that represented by the SUA arrow, once that payment advice has been processed, a response is made back from the WSI to the issuing bank (i.e., the issuer) who issued the commercial account to the account holder (i.e., the business). A messaging infrastructure, such as is seen in FIG. 4, can facilitate a response from the WSI back to the issuer so that the issuer is fully apprised of all matters dealing with accounts upon which its account holders will make payments to its suppliers. As can be seen in FIG. 4, the payment messaging infrastructure facilitates a return of a response back from the issuer and also notifies a requestor at the initial box labeled “Payment Instructions/Request”.

Environment 400 also shows an audit and traceability data collection process. Additionally, there is a batch reconciliation module where a settlement database is in communication with the data reconciliation process. The data reconciliation process involves an automatic reset engine for the purposes of the batch reconciliation. Accordingly, although environment 400 facilitates real time payment of suppliers by account holders through either single use accounts or expansion of credit in an existing account, nevertheless, a reconciliation batch, non-real time, process can take place for those suppliers that have been paid by an account holder by use of various accounts issued to the account holder by an issuer. Also shown is traceability in data auditing reports through the infrastructure seen in environment 400 as well as a subscription service for meta data capture (which can be a manual process).

A process 500 shows a credit limit adjustment process having the various steps that are depicted. Process 500 is a further illustration of the environment 400 seen in FIG. 4. Process 500 begins at block 502 where a capture is made of processed settlements from various bills that have been sent to an account holder (i.e., a business) by various suppliers. Process 500 moves to block 504 where, for all unmatched pending instructions, there is a matching process that takes place to match each request (payment instructions requests for existing invoices and requisition requests for future invoices) to a corresponding settlement. A query is made at box 506 as to whether or not the payment requests have been matched. If they have, then process 500 moves to block 508 for a further query as to whether or not a credit limit reset has been requested. If the payment has not been matched at box 506, then the result of the query is that process 500 moves to block 522 where it is determined whether or not the request is expired. If the request has expired, then process 500 moves to block 524. If the query at blocks 506 and 508 are both answered in the affirmative, then again, process 500 moves to block 524.

At block 524, there is a call made for processor service, which involves a request to adjust the credit limit on a commercial account that is to be used by an account holder to pay a supplier. Box 524 communicates with a card management web services to send and receive messages through a messaging infrastructure complex 528. The messaging infrastructure complex 528 facilitates one of three different types of processor provided web services seen in box 530. The processor service of the web services can be provided by a transaction handler or its agent(s), such as transaction handler (th) 802 seen in FIG. 8 as more fully explained below. These processor provided web services facilitate several different functions with the issuer of commercial accounts, including: (i) adjusting the limit on a commercial account issued by an issuer to an account holder so that there will be sufficient funds available or credit available for the account holder to make a payment to a supplier; (ii) facilitating the availability of a new Single-Use-Account from which payments can be made to a supplier by an account holder to whom the SUA is issued; and (iii) making an adjustment to a credit limit of an existing commercial account.

At box 524, process 500 proceeds to box 512 to determine whether or not the processing of payment instructions has been successful. If the process has not been successful, then process 500 moves to box 530. At box 530, a mark or other report is made as to the status showing that the credit limit reset failed. A triggering of an exception alert is made at box 530, and process 500 thereafter terminates at box 532 in a failure. Optionally, a message can be sent characterizing the failure through the messaging infrastructure complex 528 via card management service 526.

If the query at box 512 determines that the processing of the payment instructions has been successful, then process 500 moves to block 514. At block 514, a status is set that the instructions are closed, and notifications are sent accordingly regarding the matched payment instructions and the expired payment instructions. Once the set instructions has been closed as to status at box 514, the process 500 moves to box 516 where a query is made as to whether or not the commercial account was a SUA. If not, then process 500 is completed at box 520 indicating that there has been a success. If, however, the commercial account in a SUA, then the SUA is returned to a pool of accounts at block 518 and process 500 terminates at box 520 in a success.

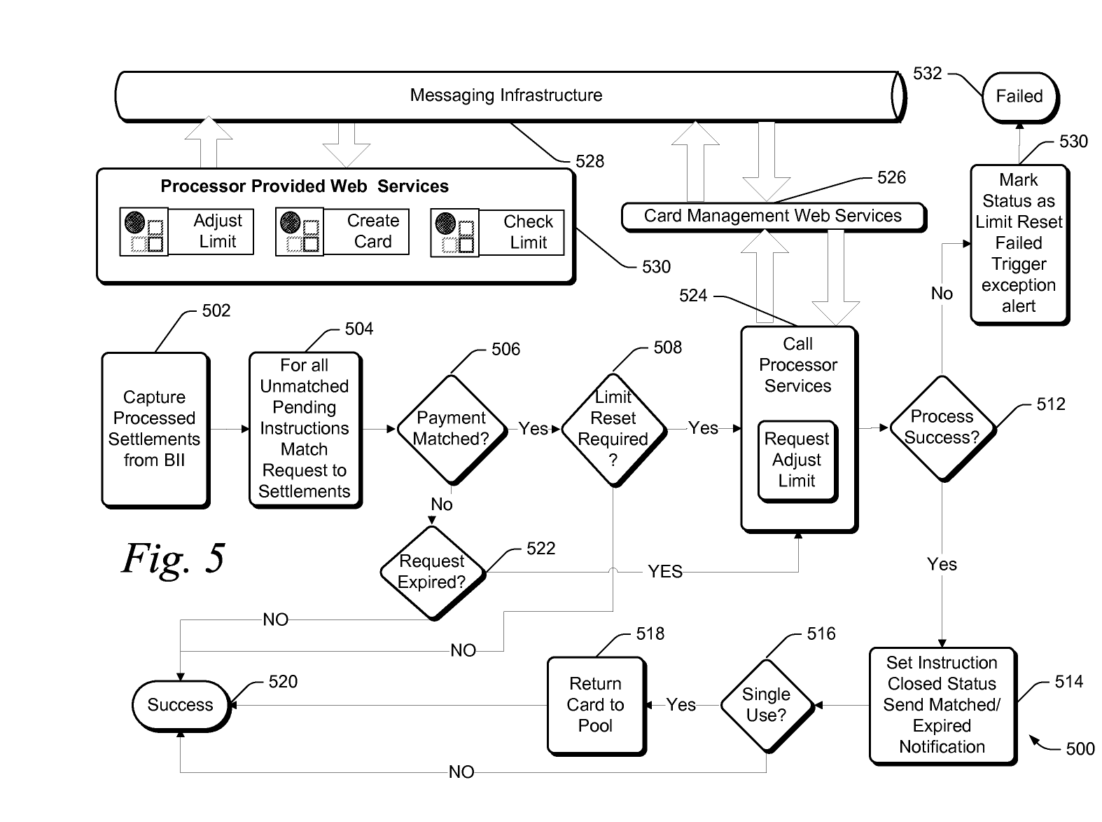

At the query seen in box 508, which is whether or not an adjustment needs to be made on a credit limit on an account, if there is no need to adjust to the credit on account, then process 500 can move to completion at box 520 because there is no need for adjustment on the account that has already been identified for the purpose of payment instructions. FIG. 5 shows method 500 for adjusting limits on accounts issued by an issuer to an account holder. As used herein, the account holder can hold one or more accounts from the issuer. The issuer will work with process 500 to adjust limits on accounts appropriately so that payments can be made to the account holder's suppliers for various goods and services provided to the account holder or are provided to another entity for which the account holder is financially responsible. These adjustments to credit limits on various accounts take place in a web services infrastructure through various processor provided web services. The messaging that flows within process 500 will preferably be a mark-up language in typical use for the World Wide Web and/or internet communications protocol. These messaging services are seen at box 526 labeled ‘Card Management Web Services’. Box 528, labeled ‘Messaging Infrastructure’, facilitates communications with those functions as are illustrated in Box 530 labeled “Processor Provided Web Services” and are illustrated in Box 528 labeled “Card Management Web Services”.

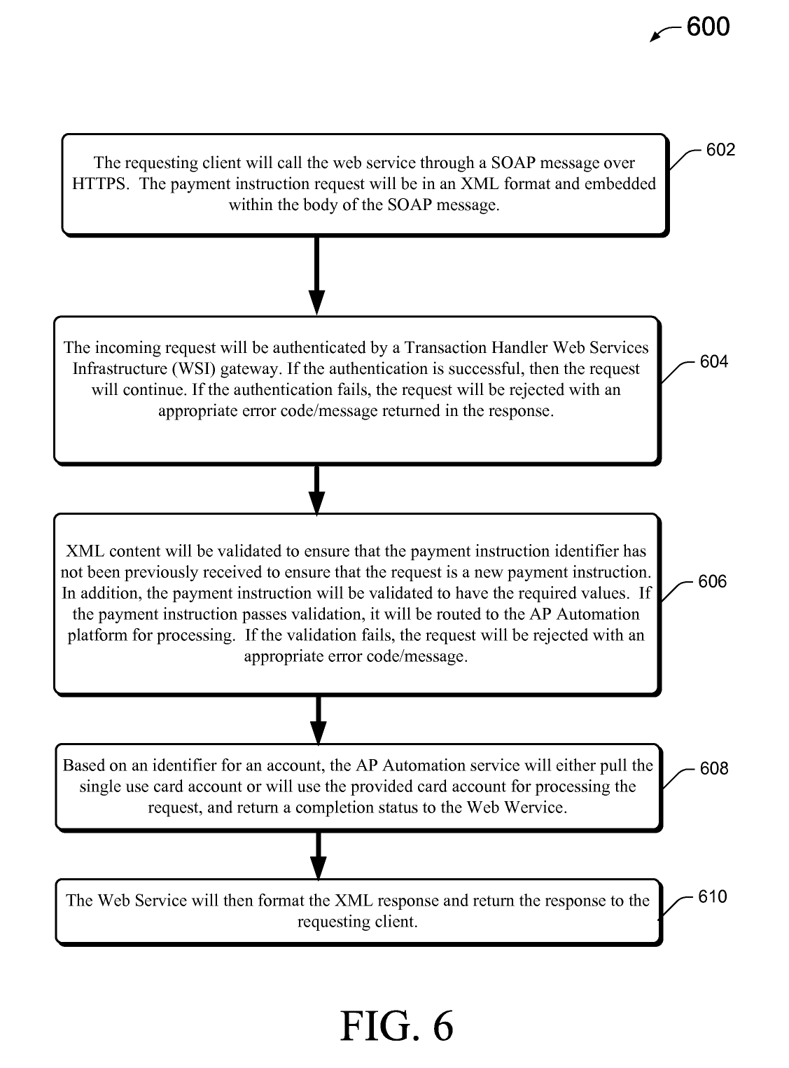

FIG. 6 depicts a flow chart of an exemplary method 600 for processing a payment request from a client such as requestor-client 102, 202 and 302 seen in FIGS. 1-3. At a step 602 of process 600, the requesting client will call the web service through a SOAP message over HTTPS. The payment instructions request will preferably be in an XML format that is embedded within a SOAP body. At a step 604 of process 600, the incoming request will be authenticated by a Transaction Handler Web Services Infrastructure (WSI) gateway (e.g., see Box 108, 208 and 308 seen in FIGS. 1-3, respectively). By way of example, the ‘Transaction Handler’ can be facilitated by transaction handler (th) 802 seen in FIG. 8 or by agent(s) thereof. If the authentication fails, the payment request will be rejected with an appropriate error code/message that is returned in the response to the payment request (e.g., see Box 120, 220 and 320 seen in FIGS. 1-3, respectively).

If the authentication is successful, then the processing of the request will continue, and process 600 moves to box 606. At box 606, XML content will be validated to ensure that a payment instruction identifier has not been previously received, thereby ensuring that the request is a new payment instruction. In addition, there will be a validation that the payment instruction has any required values (e.g., see Box 112, 212 and 312 seen in FIGS. 1-3, respectively). If the validation fails, the payment request will be rejected with an appropriate error code/message returned in the response to the payment request (e.g., see Box 120, 220 and 320 seen in FIGS. 1-3, respectively).

If the payment request passes validation, it will be routed to an AP Automation platform (e.g.; see reference numeral 708 in FIG. 7) for processing and process 600 moves to box 608. At box 608, based on an identifier for a commercial account, an account payable automation service will either pull a SUA or will use an existing provided commercial account for processing the payment request, and will then return a completion status to the web service. Process 600 then moves to box 610 at which the web service will format an XML response (e.g., see Box 118, 218 and 321 seen in FIGS. 1-3, respectively) to the payment request that is sent for delivery to the requesting client such as requestor-client 102, 202 and 302 seen in FIGS. 1-3.

FIG. 7 shows an Environment 700 in which an issuer 702 is in communication through the internet with a network device 704. The issuer, an example of which is seen in FIG. 8 as issuer (i) 804, issues a commercial account to a business, an example of which is seen in FIG. 8 as account holder (a) 808. The network device 704 is in communication through a web services interface with a transaction handler's accounts payable online web services module 706. An example of a transaction handler is seen in FIG. 8 as transaction handler (th) 802. By way of example, and not by way of limitation, a transaction handler can be a payment card company such as Visa Inc., MasterCard, American Express, Discover Card, Diners Club, etc. The transaction handler accounts payable online web services module 706 is in communication with an accounts payable processing platform 708 through a transaction handler web services interface. Examples of the accounts payable processing platform 708 are referred to in FIG. 1-3 at reference numerals 114, 214, and 318, respectively.

In certain implementations, individual blocks described above may be combined, eliminated, or reordered. In certain implementations, instructions are encoded in computer readable medium wherein those instructions are executed by hardware (e.g.; one or more processors) to perform one or more of the blocks seen in FIGS. 1-7. In yet other implementations, instructions reside in any other computer program product, where those instructions are executed by a computer external to, or internal to, a computing system to perform one or more of the blocks seen in FIGS. 1-7 In either case the instructions may be encoded in a non-transient computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like. The steps of a method, process, or algorithm described in connection with the implementations disclosed herein may be embodied directly in hardware, in a software module executed by a processor, or in a combination of the two. In certain implementations, instructions are encoded in computer readable medium wherein those instructions are executed by a processor to perform one or more of the steps recited in describing FIG. 1-7.

Payment Processing System

Turning now to FIG. 8, an exemplary payment processing system 800 is illustrated to depict a general environment in which the methods 100-700 can be performed. In payment processing system 800, a merchant (m) 810 can conduct a transaction for goods and/or services with an account user (au) on an account (i.e., a prepaid account) issued to an account holder (a) 808 by an issuer (i) 804, where the processes of paying and being paid for the transaction are coordinated by a transaction handler (th) 802, where the transaction handlers 802 include transaction handler (1) through transaction handler (TH), and where TH can be up to and greater than an eight digit integer. The transaction includes participation from different entities that are each a component of the payment processing system 800.

Payment processing system 800 has a plurality of merchants 810 that includes merchant (1) 810 through merchant (M) 810, where M can be up to and greater than an eight digit integer.

Payment processing system 800 has a plurality of prepaid accounts 808 each of which is held by a corresponding account holder (1) 808 through account holder (A) 808, where A can be up to and greater than a ten digit integer.

Payment processing system 800 includes account user (1) 808 through account user (AU) 808, where AU can be as large as a ten digit integer or larger. Each account user (au) 808 conducts a transaction for goods and/or services with merchant (m) 810 using an account (i.e., a prepaid account) that has been issued by an issuer (i) 804 to a corresponding account holder (a) 808. Data from the transaction on the account is collected by merchant (m) 810 and forwarded to a corresponding acquirer (q) 806. Acquirer (q) 806 forwards the data to transaction handler 802 who facilitates payment for the transaction from the prepaid account issued by the issuer (i) 804 to account holder (a) 808.

Payment processing system 800 has a plurality of issuers 804. Each issuer (i) 804 may be assisted in processing one or more transactions by a corresponding agent issuer (ai) 804, where ‘i’ can be an integer from 1 to I, where ‘ai’ can be an integer from 1 to AI, and where I and AI can be as large as an eight digit integer or larger.

Payment processing system 800 has a plurality of acquirers 806. Each acquirer (q) 806 may be assisted in processing one or more transactions by a corresponding agent acquirer (aq) 806, where ‘q’ can be an integer from 8 to Q, where aq can be an integer from 8 to AQ, and where Q and AQ can be as large as an eight digit integer or larger.

Payment processing system 800 has a transaction handler 802 to process a plurality of transactions. The transaction handler 802 can include one or a plurality of networks and switches 802. Each network/switch (ns) 802 can be a mainframe computer in a geographic location different than each other network/switch (ns) 802, where ‘ns’ is an integer from one to NS, and where NS can be as large as a four digit integer or larger.

Dedicated communication systems 820, 822 (i.e., private communication network(s)) facilitate communication between the transaction handler 802 and each issuer (i) 804 and each acquirer (q) 806. The Internet 812, via e-mail, the World Wide Web, cellular telephony, and/or other optional public and private communications systems, can facilitate communications 822a-822e among and between each issuer (i) 804, each acquirer (q) 806, each merchant (m) 810, each account holder (a) 808, and the transaction handler 802. Alternatively and optionally, one or more dedicated communication systems 824, 826, and 828 can facilitate respective communications between each acquirer (q) 806 and each merchant (m) 810, each merchant (m) 810 and each account holder (a) 808, and each account holder (a) 808 and each issuer (i) 804, respectively.

Each acquirer (q) 806 may be assisted in processing one or more transactions by a corresponding agent acquirer (aq) 806, where ‘q’ can be an integer from 8 to Q, where aq can be an integer from 8 to AQ, and where Q and AQ can be as large as an eight digit integer or larger.

Merchant (m) 810 may be a person or entity that sells goods and/or services. Merchant (m) 810 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 808 may be a second merchant making a purchase from another merchant (m) 810. Merchant (m) 810 may utilize at least one point-of-sale terminal (POS) that can communicate with acquirer (q) 806, transaction handler 802, or issuer (i) 804. Thus, the POS terminal is in operative communication with the payment processing system 800.

Typically, a transaction begins with account user (au) 808 presenting a portable consumer device to merchant (m) 810 to initiate an exchange for a good or service. The portable consumer device may be associated with an account (e.g., a prepaid account) of account holder (a) 808 that was issued to the account holder (a) 808 by issuer (i) 804.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 808's name.

Merchant (m) 810 may use the POS terminal to obtain account information, such as a number of the account of the account holder (a) 808, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 804 of the account corresponding to the portable consumer device. Alternatively, or in combination, the portable consumer device may communicate with issuer (i) 804, transaction handler 802, or acquirer (q) 806.

Issuer (i) 804 may authorize the transaction using transaction handler 802. Transaction handler 802 may also clear the transaction. Authorization includes issuer (i) 804, or transaction handler 802 on behalf of issuer (i) 804, authorizing the transaction in connection with issuer (i) 804's instructions such as through the use of business rules. The business rules could include instructions or guidelines from transaction handler 802, account holder (a) 808, merchant (m) 810, acquirer (q) 806, issuer (i) 804, a related financial institution, or combinations thereof. Transaction handler 802 may maintain a log or history of authorized transactions. Once approved, merchant (m) 810 will record the authorization, allowing account user (au) 808 to receive the good or service from merchant (m) 810 or an agent thereof.

Merchant (m) 810 may, at discrete periods, such as the end of the day, submit a list of authorized transactions to acquirer (q) 806 or other transaction related data for processing through the payment processing system 800. Transaction handler 802 may compare the submitted authorized transaction list with its own log of authorized transactions. If a match is found, transaction handler 802 may route authorization transaction amount requests from the corresponding acquirer (q) 806 to the corresponding issuer (i) 804 involved in each transaction. Once acquirer (q) 806 receives the payment of the authorized transaction amount from issuer (i) 804, acquirer (q) 806 can forward the payment to merchant (m) 810 less any transaction costs, such as fees for the processing of the transaction. If the transaction involves a debit or pre-paid card, acquirer (q) 806 may choose not to wait for the issuer (i) 804 to forward the payment prior to paying merchant (m) 810.

There may be intermittent steps in the foregoing process, some of which may occur simultaneously. For example, acquirer (q) 806 can initiate the clearing and settling process, which can result in payment to acquirer (q) 806 for the amount of the transaction. Acquirer (q) 806 may request from transaction handler 802 that the transaction be cleared and settled. Clearing includes the exchange of financial information between the issuer (i) 804 and the acquirer (q) 806 and settlement includes the exchange of funds. Transaction handler 802 can provide services in connection with settlement of the transaction. The settlement of a transaction includes depositing an amount of the transaction settlement from a settlement house, such as a settlement bank, which transaction handler 802 typically chooses, into a clearinghouse, such as a clearing bank, that acquirer (q) 806 typically chooses. Issuer (i) 804 deposits the same from a clearinghouse, such as a clearing bank, which issuer (i) 804 typically chooses, into the settlement house. Thus, a typical transaction involves various entities to request, authorize, and fulfill processing the transaction.

Payment processing system 800 will preferably have network components suitable for scaling the number and data payload size of transactions that can be authorized, cleared and settled in both real time and batch processing. These include hardware, software, data elements, and storage network devices for the same. Examples of payment processing system 800 include those operated, at least in part, by American Express, Master Card, Discover Card, First Data Corporation, Diners Club, and Visa Inc., and agents of the foregoing.

Each network/switch (ns) 802 can include one or more data centers for processing transactions, where each transaction can include up to 100 kilobytes of data or more. The data corresponding to the transaction can include information about the types and quantities of goods and services in the transaction, information about the account holder (a) 808, the account user (au) 808, the merchant (m) 810, tax and incentive treatment(s) of the goods and services, coupons, rebates, rewards, loyalty, discounts, returns, exchanges, cash-back transactions, etc.

By way of example, network/switch (ns) 802 can include one or more mainframe computers (i.e., one or more IBM mainframe computers) for communications over systems 820, 822, one or more server farms (i.e., one or more Sun UNIX Superservers), where the mainframe computers and server farms can be in diverse geographic locations.

Each issuer (i) 804 (or agent issuer (ai) 804 thereof) and each acquirer (q) 806 (or agent acquirer (aq) 806 thereof) can use one or more router/switch (i.e., Cisco routers/switches) to communicate with each network/switch (ns) 802 via dedicated communication systems 820, 822, respectively.

Transaction handler 802 stores information about transactions processed through payment processing system 800 in data warehouses such as may be incorporated as part of the plurality of networks/switches 802. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 800 over paying and being paid by cash, checks, or other traditional payment mechanisms.

FIG. 8 includes one or more transaction handlers transaction handler (th) 802 and access points 830, 832. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handler (th) 802) to remote entities use dedicated high-bandwidth telephone circuits or satellite connections based on the IBM SNA-LU0 communication protocol. Messages are sent over these lines using any suitable implementation of the ISO 8583 standard.

Access points 830, 832 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 806 and its access point, and between the access point and issuer (i) 804 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

Transaction handler (th) 802 can store information about transactions processed through transaction processing system 800 in data warehouses such as may be incorporated as part of the plurality of networks/switches 802. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 800 over paying and being paid by cash, or other traditional payment mechanisms.

The VisaNet® system is an example component of the transaction handler (th) 802 in the transaction processing system 800. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 810. In 2007, around 71 billion transactions for about 4 trillion U.S. dollars were cleared and settled through the VisaNet® system, some of which involved a communication length of around 24,000 miles in around two (2) seconds and during which a plurality of stops are made for processing data in the transaction.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The steps of a method, process, or algorithm described in connection with the implementations disclosed herein may be embodied directly in hardware, in a software module executed by a processor, or in a combination of the two. In certain implementations, instructions are encoded in computer readable medium wherein those instructions are executed by a processor to perform one or more of the steps recited.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps, each being performed by computing hardware executing software, wherein the steps include:
receiving, at a web service, a request from a client to identify one commercial account in a pool of said commercial accounts, wherein:
the one commercial account is unused and other said commercial accounts in the pool of said commercial account are in use;
the requested one unused commercial account is to be used to make one payment thereon to a supplier of an account holder for an invoice from the supplier; and
the request includes a credit limit for the requested unused one commercial account;
sending, from the web service to an issuer of the requested unused one commercial account, a request to determine the availability of:
the requested unused one commercial account in the pool of said commercial accounts; and
the requested credit limit from available credit offered by the issuer to the account holder to whom the issuer issued each said commercial account in the pool of said commercial accounts;
receiving, at the web service, a response to the request from the issuer;
and
when the response includes information verifying that both the requested unused one commercial account and the requested credit limit for the requested unused one commercial account are determined to be available, sending payment instructions to the issuer to make an electronic payment of the invoice to the supplier for the invoice by use of the available credit limit of the requested unused one commercial account, wherein the receiving of the request, the sending of the request to the issuer, and the receiving of the response from the issuer all occur in real time.

2. The method as defined in claim 1, wherein:
each of the received request and the received response to the request comprises a transmission containing data in a format of a markup language; and
the payment instructions sent to the issuer comprises a transmission containing data in a format of a markup language.

3. The method as defined in claim 1, wherein each of the receiving of the request, the sending of the request to the issuer, and the receiving of the response from the issuer are performed by a transaction handler in communication with an acquirer for the supplier and the issuer to facilitate processing of a transaction on the requested unused one commercial account pertaining to the invoice with respect to authorization, clearing and settlement.

4. An apparatus comprising one or more servers in communication over a network for performing the method of claim 1.

5. A non-transient computer readable medium having instructions executable by hardware to perform the method of claim 1.

6. A method comprising a plurality of steps, each being performed by computing hardware executing software, wherein the steps include:
receiving, at a web service, a request from a client to adjust a credit limit by a currency amount for a commercial account to be used to make a payment thereon to a supplier of an account holder for an invoice from the supplier;
sending, from the web service to an issuer of the commercial account, an identifier for the account and the currency amount with a request to determine the availability of the requested adjustment to the credit limit of the commercial account by the currency amount from available credit offered by an issuer of the commercial account who issued the commercial account to the account holder;
receiving, at the web service, a response to the request from the issuer;
and
when the response includes information verifying that both the commercial account and the requested credit limit adjustment for the commercial account are determined to be available, sending payment instructions to the issuer to make an electronic payment of the invoice to the supplier by use of the adjusted credit limit of the commercial account, wherein the receiving of the request, the sending of the request to the issuer, and the receiving of the response from the issuer all occur in real time.

7. The method as defined in claim 6, wherein:
each of the received request and the received response to the request comprises a transmission containing data in a format of a markup language; and
the payment instructions sent to the issuer comprises a transmission containing data in a format of a markup language.

8. The method as defined in claim 6, wherein each of the receiving of the request, the sending of the request to the issuer, and the receiving of the response from the issuer are performed by a transaction handler in communication with an acquirer for the supplier and the issuer to facilitate processing of a transaction on the commercial account pertaining to the invoice with respect to authorization, clearing and settlement.

9. An apparatus comprising one or more servers in communication over a network for performing the method of claim 6.

10. A non-transient computer readable medium having instructions executable by hardware to perform the method of claim 6.

11. A method comprising a plurality of steps, each being performed by computing hardware executing software, wherein the steps include:
receiving, at an issuer, from a web service, a request to determine the availability of:
an unused commercial account in the pool of said commercial accounts, wherein the unused commercial account is to be used to make one payment thereon to a supplier of an account holder for an invoice from the supplier; and
a credit limit offered by the issuer to the account holder to whom the issuer issued each said commercial account in the pool of said commercial accounts;
determining, at the issuer, the availability of:
the requested unused commercial account in the pool of said commercial accounts; and
the requested credit limit;
sending, from the issuer to the web service, a response to the request from the issuer having information verifying that both the requested unused one commercial account and the requested credit limit for the requested unused one commercial account are determined to be available;
receiving, at the issuer, from the web service, payment instructions to make an electronic payment of the invoice to the supplier for the invoice by use of the available credit limit of the requested unused one commercial account; and
sending, from the issuer, a payment of the invoice for the benefit of the supplier by use of the available credit limit of the requested unused one commercial account, wherein the receiving of the request, the sending of the response, the receiving of the payment instructions, and the sending of the payment of the invoice all occur in real time.

12. The method as defined in claim 11, wherein each of the request, the response, and the payment instructions comprise one more transmissions each containing data in a format of a markup language.

13. The method as defined in claim 11, wherein the web service is a transaction handler in communication with an acquirer for the supplier and with the issuer to facilitate processing of a transaction on the requested unused one commercial account pertaining to the invoice with respect to authorization, clearing and settlement.

14. An apparatus comprising one or more servers in communication over a network for performing the method of claim 11.

15. A non-transient computer readable medium comprising instructions executable by hardware to perform the method of claim 11.

16. A method comprising a plurality of steps, each being performed by computing hardware executing software, wherein the steps include:
receiving, at an issuer of a commercial account, from a web service, an identifier for the commercial account and a currency amount derived from a request originating from a client in communication with the web service, wherein the request is for a determination of an availability of an adjustment to a credit limit of the commercial account by the currency amount from available credit offered by the issuer of the commercial account who issued the commercial account to a account holder, wherein the request from the client is to make a payment of the currency amount from the commercial account to a supplier of the account holder for an invoice from the supplier;
determining, at issuer, using the identifier for the identifier for the commercial account and the currency amount, the availability of the adjustment to the credit limit of the commercial account by the currency amount for the account holder;
sending, from the issuer to the web service, a response to the request that includes information verifying that both the commercial account and the requested credit limit adjustment for the commercial account are determined to be available;
receiving, at the issuer, from the web service, payment instructions to make an electronic payment of the invoice to the supplier by use of the adjusted credit limit of the commercial account; and
sending, from the issuer to the web service, a payment of the invoice for the benefit of the supplier by use of the available credit limit of the commercial account, wherein the receiving of the request, the determining, the sending of the response, the receiving of the payment instructions, and the sending of the payment of the invoice all occur in real time.

17. The method as defined in claim 16, wherein each of the request, the response, and the payment instructions comprise one more transmissions each containing data in a format of a markup language.

18. The method as defined in claim 16, wherein the web service is a transaction handler in communication with an acquirer for the supplier and with the issuer to facilitate processing of a transaction on the commercial account pertaining to the invoice with respect to authorization, clearing and settlement.

19. An apparatus comprising one or more servers in communication over a network for performing the method of claim 16.

20. A non-transient computer readable medium comprising instructions executable by hardware to perform the method of claim 16.
